(19) United States
(12) Patent Application Publication
(10) Pub. No.: US 2011/0258356 A1
(43) Pub. Date: Oct. 20, 2011

(54) HOST APPARATUS AND OPERATION SYSTEM AND CONTROL METHOD THEREOF

(75) Inventors: Johnny CHEN, Santa Ana, CA (US); Chien-Kuan Ho, Santa Ana, CA (US)

(73) Assignee: I/O INTERCONNECT, LTD., Santa Ana, CA (US)

(21) Appl. No.: 13/047,986

(22) Filed: Mar. 15, 2011

Related U.S. Application Data
(60) Provisional application No. 61/324,451, filed on Apr. 15, 2010.

(51) Int. Cl. G06F 13/14

(52) U.S. Cl. 710/301

(57) ABSTRACT

An operation system module provided by the present invention comprises an interface slot unit, an interface card and a memory card. The interface slot is disposed on a circuit board. In addition, the interface card can be inserted into the interface slot unit. Wherein, the interface card has a memory card slot, so that the memory card can be inserted into the memory card slot. In particularly, an operation system is installed into the memory card, so as to control a host apparatus working.

### CROSS-REFERENCE TO RELATED APPLICATIONS

The application claims priority of U.S. provisional patent application Ser. No. 61/324,451 filed on Apr. 15, 2010, the contents of which are hereby incorporated by reference.

### FIELD OF THE INVENTION

The present invention relates to a host apparatus, and more particularly to an operation system of a host apparatus.

### BACKGROUND OF THE INVENTION

FIG. 1 shows a block diagram of a computer system. Referring FIG. 1, the conventional computer system 100 comprises a CPU 102, a chipset 104, a memory 106, an HDD 108, and a BIOS unit 110. The CPU 102 is coupled to the chipset 104, and the chipset 104 is coupled to the memory 106, the HDD 108, and the BIOS unit 110. Wherein, an operation system 112 is installed in the HDD 108.

In addition, the BIOS unit 110 is probably a flash memory, in which a basic I/O system (BIOS) is installed. When the computer system 100 is power on, the BIOS in the BIOS unit 110 is loaded into the memory 106 through the chipset 104 by the CPU 102, so as to carry out a booting procedure. When the booting procedure is completed, the operation system 112, then, is loaded into the memory 106 through the chipset 104 by the CPU 102. Meanwhile, the work of the computer system 100 is controlled by the operation system 112.

### SUMMARY OF THE INVENTION

The present invention provides an operation system module and a control method for controlling a host apparatus to work.

The present invention further provides a host apparatus which can work without an HDD.

An operation system module provided by the present invention comprises an interface slot unit, an interface card and a memory card. The interface slot is disposed on a circuit board. In addition, the interface card can be inserted into the interface slot unit. Wherein, the interface card has a memory card slot, so that the memory card can be inserted into the memory card slot. In particularly, an operation system is installed into the memory card, so as to control a host apparatus working.

A host apparatus provided by the present invention comprises a main board, a control module, and an operation system module. The control module and the operation system module are both disposed on the main board, and coupled by each other. The operation system module comprises an interface slot unit, an interface card and a memory card. The interface slot is disposed on a circuit board. In addition, the interface card can be inserted into the interface slot unit. Wherein, the interface card has a memory card slot, so that the memory card can be inserted into the memory card slot. In particularly, an operation system is installed into the memory card. Therefore, when the memory slot is inserted into the memory card slot, the operation system can generate a plurality of control instructions to the control module through the interface slot unit for controlling the host apparatus.

A control method for a host apparatus provided by the present comprises checking whether or not a memory card is inserted into a memory card slot equipped on a interface card through a data exchange interface. When the checking result is that the memory card is already inserted into the memory card slot, it is checking whether or not an operation system is installed into the memory card through the data exchange interface. When the operation system is installed into the memory card, loading the operation system installed from the memory card through the data exchange interface.

In some embodiment in the present invention, the data exchange interface is PCIe interface.

Since the operation system can be installed into the memory card, and the memory card can be inserted into the memory card slot of the interface card which is inserted into the interface slot unit, the operation system can be loaded for controlling the host apparatus to work.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 shows a block diagram of a computer system.

FIG. 2 shows a system block diagram of a host apparatus according to one preferred embodiment of the present invention.

FIG. 3 shows a system block diagram of an operation system module according to one preferred embodiment of the present invention.

FIG. 4 shows a flow chart of a control method for a host apparatus according to one preferred embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

FIG. 2 shows a system block diagram of a host apparatus according to one preferred embodiment of the present invention. Referring FIG. 2, a host apparatus 200 provided by the exemplary embodiment is probably a desktop personal computer (PC), a portable PC, a server system, or a work station. In this exemplary embodiment, the host apparatus 200 comprises a main board 202, such like printed circuit board. In addition, the host apparatus 200 further comprises a control module 204 and an operation system module 206 disposed on the main board 202. Wherein, the control module 204 is coupled to the operation system module 206 through a data exchange interface 208.

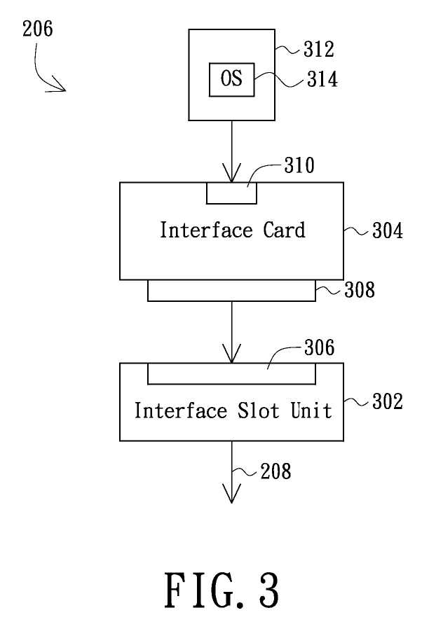

FIG. 3 shows a system block diagram of the operation system module according to one preferred embodiment of the present invention. Referring FIG. 3, the operation system module 206 comprises an interface slot unit 302 and an interface card 304. The interface slot unit 302 is coupled to the data exchange interface 208, such as the PCIe interface. In addition, the interface slot unit 302 has an interface card slot 306. Therefore, the interface card, such as a PCIe interface card, can be inserted into the interface card slot 306 by a connecting portion 308.

The interface card 304 has a memory card slot 310. Wherein, the memory card slot 310 is conformed at least one predetermined specification of a memory card. So that a memory card 312 conformed to the predetermined specification can be inserted into the memory card slot 310. In this exemplary embodiment, the memory card 312 is probably a PCMCIA card, CF card (type 1 and 2), SD card, mini SD card, micro SD card, SDHC card, T flash card, MMC card, RS-MMC card, MS card (Pro, Pro Duo, and micro), SM card, xD card, SDXC card, MS XC card, etc.

In particularly, an operation system 314 is installed into the memory card 312. Therefore, when the memory card 314 is inserted into the memory card slot 310. The operation system 314 can be loaded by the control module 204 (referring FIG. 2) through the data exchange interface 208, such as PCIe interface.

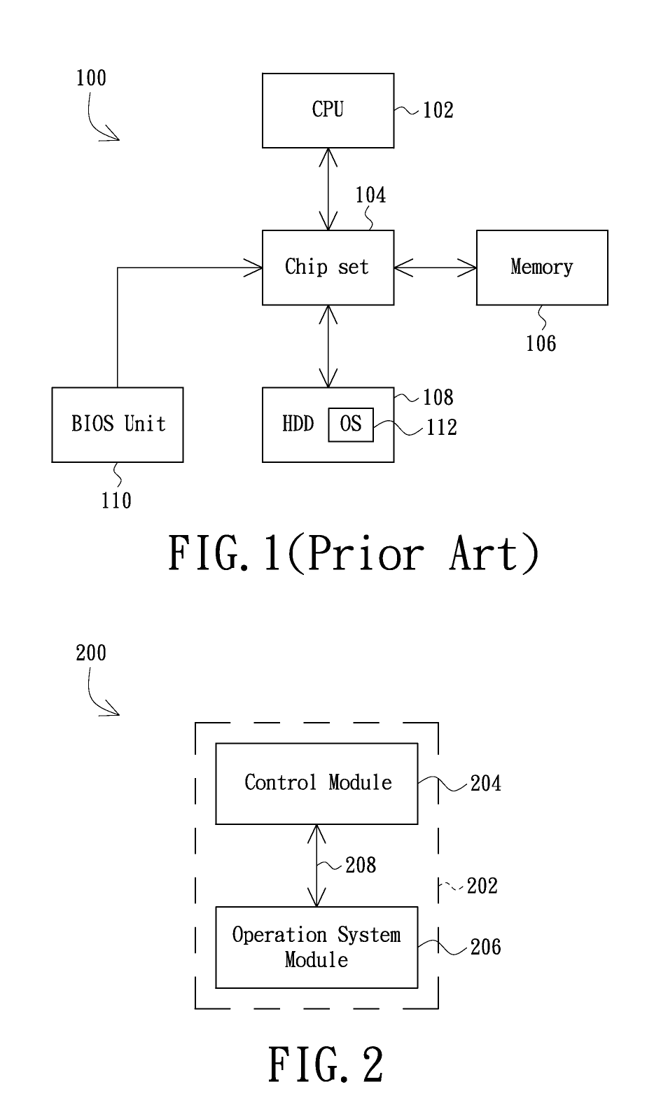

Since the memory card 312 has the operation system 314, the operation system module 206 in the present invention has ability to displace an HDD, such as HDD 108 in FIG. 1. Because the PCIe interface is a standard equipment in most host apparatuses, the hard architecture of these host apparatuses is unnecessary to be changed to implement the operation system module 206 and the hardware cost of thereof would not be increased. In addition, the transmission speed of some PCIe interface, ideally, can reach 8 GB per second, thus the data can be exchanged fast between the control module 204 and the operation system module 206.

In another advantage of the present invention, because the memory card is facilitated to carry, a user can implement the operation system module 206 in some host apparatuses with PCIe interface, no matter the host apparatuses with PCIe interface equip with the HDD or not.

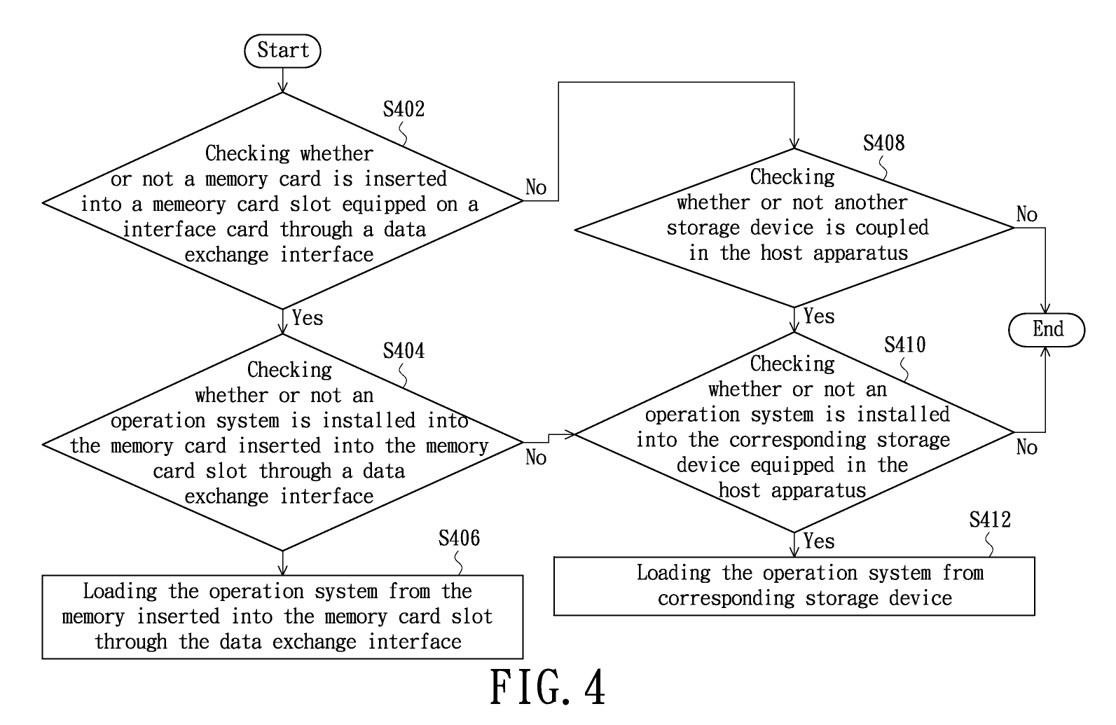

FIG. 4 shows a flow chart of a control method for a host apparatus according to one preferred embodiment of the present invention. Referring FIG. 4, when a host apparatus is power on, in this exemplary embodiment, the step S402 can be performed to check whether or not a memory card is inserted into a memory card slot equipped on an interface card through a data exchange interface, such like PCIe interface. If no memory card is inserted into the memory card slot (i.e. “No” labeled on step S402), goes to the step S408. On the contrary, if confirming the memory card be already inserted into the memory card slot (i.e. “Yes” labeled on step S402), goes to the step S404 to check whether or not an operation system is installed into the memory card, which is inserted into the memory slot, through the data exchange interface.

If no operation system is installed into the memory card (i.e. “No” labeled on step S404), goes the step S408. On the contrary, if confirming the operation system be installed into the memory card inserted into the memory card slot (i.e. “Yes” labeled on step S404), the operation system is loaded from the memory card, which is inserted into the memory card slot, through the data exchange interface as description in step S406.

Referring FIG. 4 continually, if no memory card is inserted into the memory card slot or no operation system is installed into the memory card, the step S408 is performed to check whether or not another storage device, such as an HDD, a USB storage device, a optical storage media, etc., is coupled in the host apparatus. If confirming another storage device being coupled to the host apparatus (i.e. “Yes” labeled on step S408), goes the step S410 to check whether or not the operation system is installed into found storage device. If the checking result is that the operation is installed into another storage device in the host apparatus (i.e. “Yes” labeled on step S410), as mentioned in the step S412, the operation system is load from another storage device.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An operation system module, comprising:
an interface slot unit, disposed on a circuit board;
an interface card, having a memory card slot for inserting into the interface slot unit; and
a memory card, having an operation system for inserting into the memory card slot, so as to control a host apparatus working.

2. The operation system module as claimed in claim 1, wherein the interface slot unit is a PCIe slot unit, and the interface card is a PCIe interface card.

3. The operation system module as claimed in claim 1, wherein the memory card is a PCMCIA card, a CF card, a SD card, a mini SD card, a micro SD card, a SDHC card, a T Flash card, a MMC card, a RS-MMC card, a MS card, a SM card, an xD card, a SDXC card, or a MS XC card.

4. A host apparatus, comprising:
a main board;
a control module, disposed on the main board;
an operation system module, disposed on the main board and coupled to the control module, comprising:
an interface slot unit, disposed on a circuit board, and coupled to the control module;
an interface card, having a memory card slot for inserting into the interface slot unit; and
a memory card, having an operation system for inserting into the memory card slot, so as to generating a plurality of control instructions to the control module through the interface slot unit for controlling the host apparatus.

5. The host apparatus as claimed in claim 4, wherein the interface slot unit is a PCIe slot unit, and the interface card is a PCIe interface card.

6. The host apparatus as claimed in claim 4, wherein the memory card is a PCMCIA card, a CF card, a SD card, a mini SD card, a micro SD card, a SDHC card, a T Flash card, a MMC card, a RS-MMC card, a MS card, a SM card, an xD card, a SDXC card, a MS XC card.

7. The host apparatus as claimed in claim 4, is a desktop personal computer, a portable personal computer, a server system, or a work station.

8. A control method for a host apparatus, comprising:
checking whether or not a memory card is inserted into a memory card slot equipped on a interface card through a data exchange interface;
checking whether or not an operation system is installed into the memory card through the data exchange interface, when the memory card is already inserted into the memory card slot; and
loading the operation system installed from the memory card through the data exchange interface, when checking that the operation system is installed into the memory card.

9. The control method as claimed in claim 8, wherein the data exchange interface is PCIe interface.
